(19) United States
(12) Patent Application Publication
(10) Pub. No.: US 2010/0268631 A1
(43) Pub. Date: Oct. 21, 2010

(54) Structure and mechanism for REIT preferred securities

(76) Inventors: Louis Feldman, Livingston, NJ (US); Sean Brady, New York, NY (US); Salvatore Seguna, New York, NY (US)

Correspondence Address: KING & SPALDING;CREDIT SUISSE SECURITIES (USA) LLC, 1180 PEACHTREE STREET, NE, 34TH FLOOR, ATLANTA, GA, 30309-3521, US

(21) Appl. No.: 12/590,838

(22) Filed: Nov. 13, 2009

Related U.S. Application Data
(63) Continuation of application No. 11/966,517, filed on Dec. 28, 2007, now abandoned.
(60) Provisional application No. 60/877,443, filed on Dec. 28, 2006.

(51) Int. Cl. G06Q 40/00

(52) U.S. Cl. 705/37

(57) ABSTRACT

The real estate investment trust (“REIT”) structure and mechanism manages earnings distributions from the REIT to maintain REIT status. The REIT issues common stock to a bank affiliated parent (“holder”) in exchange for real estate related assets. The holder covenants to consent to consent dividends, under which the holder covenants to pay taxes on a consent dividend amount while the REIT deducts the consent dividend amount and retains the amount for each dividend period. The REIT also issues preferred securities to investors. At each dividend period, the REIT can declare cash dividends to preferred investors and/or declare consent dividends such that the REIT distributes at least a regulatory percentage of its annual income to preferred and common stockholders in order to maintain REIT status. The REIT is thus adequately capitalized, maintains status as a REIT, and receives stronger agency ratings, with regard to equity content, for the preferred securities.

### RELATED PATENT APPLICATION

This application is a continuation of and claims priority to U.S. patent application Ser. No. 11/966,517, filed on Dec. 28, 2007, titled “Structure and Mechanism for REIT Preferred Securities,” which claims priority under 35 U.S.C. §119 to U.S. Provisional Patent Application No. 60/877,443, filed Dec. 28, 2006, titled “REIT Preferred Securities,” the complete disclosure of which are hereby fully incorporated herein by reference.

This application relates to co-pending U.S. patent application Ser. No. 11/966,565, titled “Structure and Method for Mandatorily Exchangeable Preferred Securities,” filed Dec. 28, 2007. The entire disclosure of the above-identified related application is hereby fully incorporated herein by reference.

### FIELD OF THE INVENTION

The invention relates generally to Real Estate Investment Trusts (“REIT”). Specifically, the invention relates to systems and methods using covenants to consent to consent dividends to maintain an entity's REIT status and achieve rating agency equity credit treatment.

### BACKGROUND OF THE INVENTION

The concept of hybrid securities is well known in the art. Hybrid securities have some characteristics of equity, such as no mandatory ongoing payments, and loss absorption for creditors, as equity holders are typically last to receive distributions as part of a bankruptcy or liquidation. Hybrid securities also have some characteristics of debt, such as fixed payments and some loss absorption for creditors. A significant advantage of hybrid securities is that, for tax purposes, the interest paid to security holders is tax deductible for the issuer. On the other hand, dividends paid on most equity securities are generally treated as corporate income, and are taxable.

Ratings agencies, such as Moody's or Standard & Poor, rate the hybrid securities based on a debt-equity continuum for the hybrid security and generally treat those hybrid securities, to a certain extent, similar to true equity securities when assessing the overall credit quality of the issuer. Further, certain hybrid securities can receive Tier 1 capital treatment by regulators (e.g. Federal Reserve Board). Banks and bank holding companies (BHCs) that operate internationally are subject to the provisions of the Basel Accord, which regulates the type and amount of capital the banks may hold at any given time. The Basel Accord (Basel I) sets forth two types of capital: Tier 1 and Tier 2. Basel I considers Tier 1 capital to be core capital, such as, for example, common stock, non-cumulative perpetual preferred stock, disclosed reserves, and qualifying hybrid capital instruments. Tier 2 capital is supplementary capital. Banks and BHCs generally must maintain certain ratios of Tier 1 assets to total assets.

The REIT preferred security is a type of hybrid security that is known in the art. Conventional methods of managing REIT securities involve a bank establishing a REIT. The REIT would issue preferred stock to the public and common stock to the bank in exchange for cash and mortgage-related assets. Income on the assets would be distributed to the holders of REIT securities, including the preferred stockholders, and the REIT could deduct the dividends paid on the preferred and common stock.

In another conventional method, a bank establishes a REIT, which establishes a limited liability corporation (“LLC”) as a subsidiary. The LLC is treated as a partnership for tax purposes. In this structure, both the REIT and the LLC can hold REIT assets and generate income through those assets. The LLC establishes a Delaware Statutory Trust, which issues trust securities to investors. The Delaware Statutory Trust uses the proceeds from the issuance to purchase LLC Preferred Securities from the LLC.

As mentioned above, in order to be considered a hybrid security and receive equity credit treatment from the rating agencies, the issuer must be able to defer payments on the security. However, in order to maintain REIT status, the REIT must distribute 90% of its annual income under the federal tax code. Therefore, if the REIT exercises its legal ability to defer payments, it may cause the loss of REIT status for U.S. tax purposes because the REIT will be unable to meet its 90% income distribution requirement. This “tax disincentive” causes the rating agencies to put less value on the issuer's ability to defer payments and thus reduces the equity-like treatment that the security receives from the rating agencies.

The problem also exists for the LLC structure. The total income of the REIT is held between the REIT and the LLC. Therefore, if the LLC exercises its legal ability to defer payments, it may cause the loss of REIT status for U.S. tax purposes because certain income of the REIT may be trapped in the LLC, prohibiting the REIT from meeting its 90% income distribution requirement.

Thus, conventional REIT structures do not provide adequate mechanisms to ensure that the status of the REIT is maintained while meeting the requirement of the rating agencies that allow for dividend deferral. Accordingly, a need exists in the art for a REIT structure and mechanism to administer a REIT such that it maintains its REIT status while receiving higher equity-based agency ratings.

### SUMMARY OF THE INVENTION

The invention includes systems and methods for effectively structuring and administering a real estate investment trust (“REIT”). Specifically, the invention provides systems and methods for administering REIT preferred securities and REIT common stock dividends such that the REIT status is maintained, the REIT preferred securities receive higher equity credit treatment from ratings agencies, and the REIT is sufficiently capitalized.

In one exemplary embodiment, a REIT can be established as an affiliate of a first entity. In an exemplary embodiment, the first entity can be a capital corporation, a bank, or other subsidiary of a bank holding company. The first entity typically transfers REIT assets to the REIT, which can include real estate related assets. The REIT can issue at least one REIT common stock security to the first entity in exchange for the REIT assets. In addition, the first entity can covenant to consent to a consent dividend on the common stock from the REIT. In an exemplary embodiment, all of the REIT common stock securities can be transferred to the first entity. Alternatively, all of the REIT common stock securities can be held by one or more entities affiliated with the REIT.

REIT preferred securities can then be issued from the REIT to investors. In an exemplary embodiment, the REIT preferred securities can be characterized as perpetual, non-cumulative securities. In an exemplary embodiment, the REIT typically receives cash proceeds from the investors in exchange for the preferred securities. The REIT can then exchange the cash proceeds for additional eligible assets. In this exemplary embodiment, the REIT preferred securities can be callable after a time period of five years from the date of issuance. In an alternative embodiment, the time period can be ten years from the date of issuance.

During the normal course of business, the REIT declares cash dividends that it earns from its portfolio of eligible assets.

In an exemplary embodiment, the REIT can defer a cash dividend payment on the preferred securities held by investors. In this embodiment, the REIT is therefore also prohibited from making a distribution on its common stock to the bank and the bank holding company is prohibited from making payments on any of its capital stock (e.g., bank holding company preferred stock and common stock). However, in order to meet the 90% income distribution requirement established by the Internal Revenue Service, the REIT may declare a consent dividend, wherein a total amount of dividends declared can meet the minimum statutory distribution requirements to qualify as a REIT. In exemplary embodiments, the total amount of dividends can include the consent dividend and any cash dividends paid by the REIT. In one exemplary embodiment, the regulatory predetermined percentage can equal to 90%. The income tax on the consent dividend can be paid by the first entity, for example, the capital corporation, and the proceeds of the consent dividend are retained in the REIT.

In an exemplary embodiment, the bank holding company can issue bank holding company preferred securities to the investors after an event relating to a capital adequacy of the first entity occurs requiring exchange. In this embodiment, if such an event occurs, the REIT preferred securities are exchanged for the bank holding company preferred securities.

The invention thus allows for the REIT subsidiary to maintain its status as a REIT for U.S. tax purposes while also achieving the rating agency equity treatment by removing the “tax disincentive” that would otherwise prevent the issuer from deferring cash payments on the REIT preferred securities. The covenant to consent to consent dividends provides an assurance, at the outset of the transaction, that the REIT will have the ability to maintain its status and be sufficiently funded. The result is more desirable agency ratings and favorable tax treatment.

### BRIEF DESCRIPTION OF THE DRAWINGS

FIG. 1 is a block diagram depicting a representative structure of a financing program for REIT preferred securities, according to an exemplary embodiment of the present invention;

FIG. 2 is a block diagram depicting an alternative structure of a financing program according to another exemplary embodiment of the present invention;

FIG. 3 is a flow chart depicting a method for creating and administering a REIT preferred securities issuance and administration according to an exemplary embodiment of the present invention; and

FIG. 4 is a flow chart depicting a method for administering dividends from the REIT to maintain REIT status according to an exemplary embodiment of the present invention.

### DETAILED DESCRIPTION OF EXEMPLARY EMBODIMENTS

The invention is directed to the structure and administration of a real estate investment trust. The invention allows for visibility by ratings agencies as to the distribution of annual income by the REIT such that the REIT can maintain status as a REIT. In addition, the invention allows for greater retention of Tier 1 capital. Greater Tier 1 capital indicates stronger capital adequacy of the bank and reduced risk for the REIT preferred securities. As such, ratings agencies can give higher ratings, with regard to equity content, to the REIT preferred securities of the invention than to conventional REIT preferred securities. Thus, the invention provides for retention of equity while maintaining REIT status, which in turn leads to stronger agency ratings, with regard to equity content, of the preferred securities.

Turning now to the drawings, in which like numerals indicate like elements throughout the figures, exemplary embodiments of the invention are described in detail.

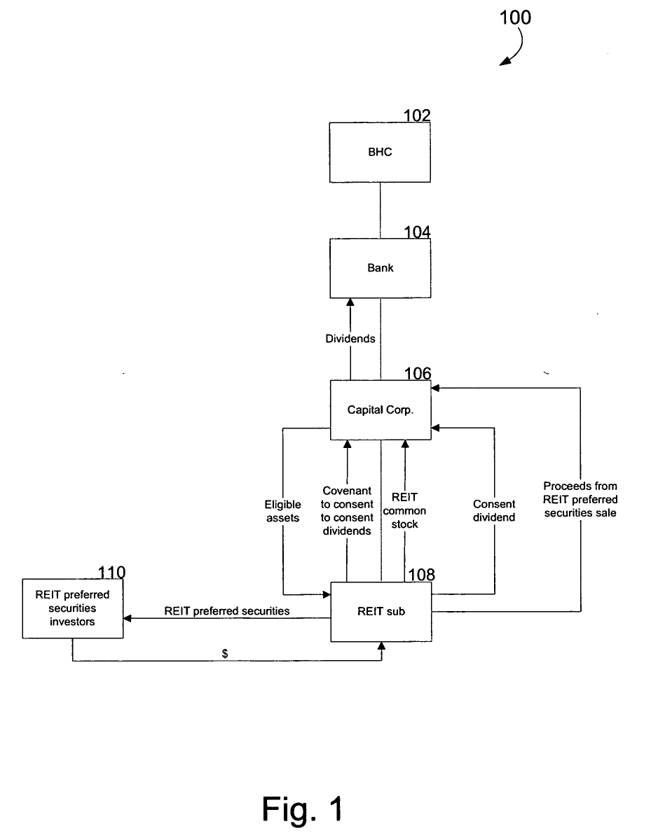

FIG. 1 is a block diagram depicting a representative structure 100 of a financing program for managing REIT preferred securities, in accordance with an exemplary embodiments of the invention. The exemplary structure 100 is illustrative and, in alternative embodiments of the invention, certain elements can be arranged differently, additional elements can be added, and/or certain elements can be omitted entirely without departing from the scope and spirit of the invention.

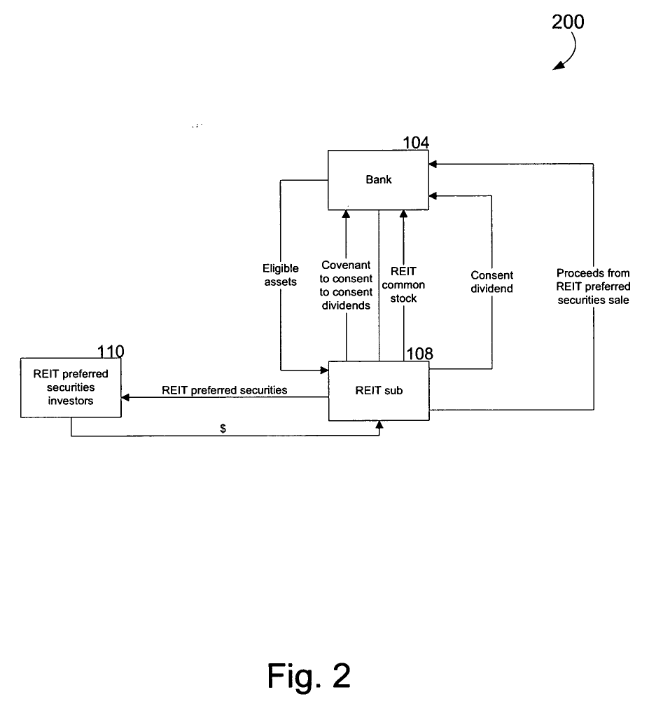

A bank holding company (“BHC”) 102 has a subsidiary, bank 104. In one exemplary embodiment, the BHC 102 is a multi-state financial holding company and operates as a financial holding company and a bank holding company under the Bank Holding Company Act of 1956. In an alternative embodiment, the BHC 102 is an international financial holding company and operates similarly to the multi-state financial holding company. In one exemplary embodiment, the bank 104 is a national banking association organized under the laws of the United States. Further, in one exemplary embodiment, the bank 104 is the largest subsidiary of the BHC 102. In an alternative embodiment, the bank could be a federal savings back and/or governed by the Office of Thrift Supervision. The exemplary bank 104 is engaged in the general banking business and provides a wide array of offerings to individuals, businesses, and institutional organizations, governmental entities, and other financial institutions. For example, the bank 104 typically provides products and services including, but not limited to: lending, savings accounts, checking accounts, asset management, credit card services, mortgages, insurance, brokerage, leasing, and other bank related products and services. In an alternative embodiment, the bank 104 can exist as an independent entity without an affiliation to the BHC 102. This alternative embodiment is discussed in more detail below with reference to FIG. 2.

The bank 104 creates a subsidiary, capital corporation 106. The capital corporation 106 is a corporate entity that can hold assets, including, but not limited to, mortgage-backed assets, proceeds from the sale of REIT preferred securities, and stock in another entity having the characteristics of a REIT.

The capital corporation 106 establishes a REIT subsidiary (“REIT sub”) 108. In one exemplary embodiment, the REIT sub 108 operates as a real estate investment trust for United States federal income tax purposes. The REIT sub 108 can be an LLC or other form of corporate entity known to those of skill in the art. In certain embodiments, the REIT sub 108 issues Series A preferred securities and Series B preferred securities, acquires and holds eligible assets, and performs functions necessary or incidental to the requirements under the United States federal income tax code. The REIT sub 108 is typically managed by a board of directors (“REIT sub board”). In one exemplary embodiment, the REIT sub board consists of three members, however, greater or fewer board members are within the scope of the present invention.

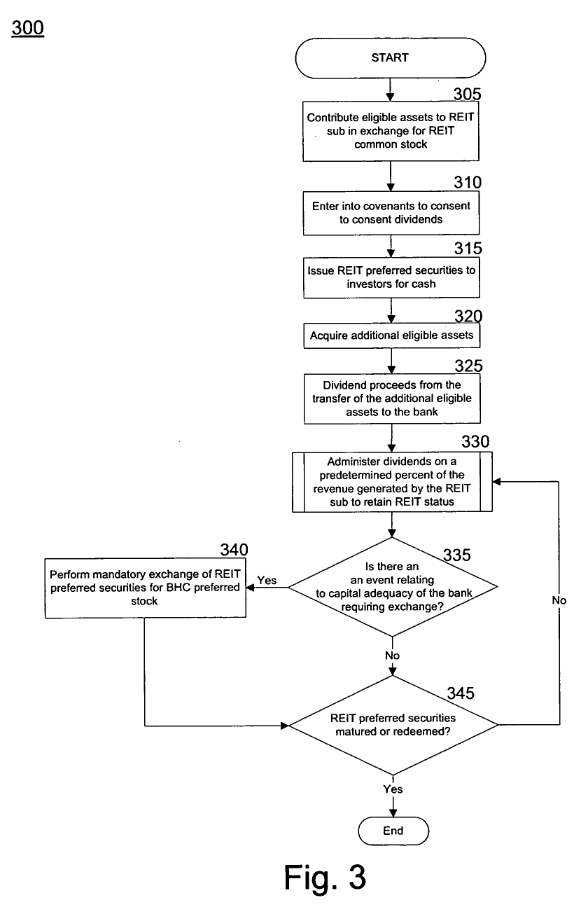

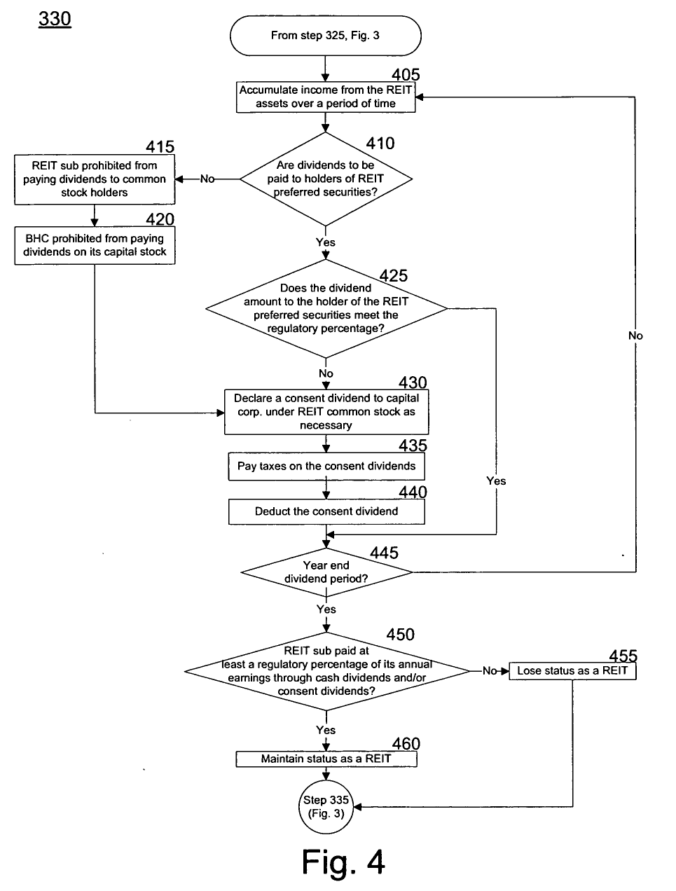

In connection with establishing the REIT sub 108, the capital corporation 106 conveys to the REIT sub 108 a portfolio of eligible assets. In certain exemplary embodiments, the eligible assets include, but are not limited to, agency mortgage-backed securities, non-agency mortgage-backed securities, and other real estate related investments, including payments thereon. In one exemplary embodiment, the eligible assets are qualifying assets for purposes of the Federal income tax code, specifically, §856. The eligible assets held by the REIT sub 108 are managed pursuant to a servicing agreement between the REIT sub 108 and capital corporation 106. In exchange for the eligible assets, the REIT sub 108 delivers a percentage of its common stock to the capital corporation 106. In one exemplary embodiment, 100% of the common stock of the REIT sub 108 is transferred to the capital corporation 106 or another entity affiliated or owned by the BHC 102. However, those of ordinary skill in the art will recognize that percentages other than 100% can be received by the capital corporation 106 in exchange for the eligible assets. The exchange of eligible assets for common stock will be discussed in more detail herein with reference to FIG. 3. Also in connection with the exchange of REIT common stock for eligible assets, the capital corporation 106 covenants to consent to consent dividends under the REIT common stock. The covenant to consent to consent dividends is discussed in more detail herein with references to FIGS. 3 and 4.

The REIT sub 108 issues securities to the REIT preferred securities investors 110. In one exemplary embodiment, the REIT sub 108 issues REIT preferred securities to the investors 110 in exchange for cash or other liquid assets. In this exemplary embodiment, the REIT preferred securities are fixed-to-floating rate, exchangeable, non-cumulative, perpetual series A preferred stock. In one exemplary embodiment, the REIT preferred securities are securities of a subsidiary of the BHC 102. The securities can be callable after a predetermined amount of time. In one exemplary embodiment, the securities are callable after five years. In an alternative embodiment, the securities are callable after three years. Those of ordinary skill in the art will recognize that securities may be callable for periods greater than five years, for example seven years, less than three years or between three and five years and still be within the scope of the present invention. The REIT preferred securities are senior to the REIT common stock with respect to the payment of dividends and liquidation preference. The issuance of REIT preferred securities will be discussed in more detail herein with reference to FIG. 3.

The REIT sub 108 can use the proceeds received from the investors 110 from the sale of REIT preferred securities to acquire additional eligible assets from the bank 104, any other subsidiary of the BHC 102, including capital corporation 106, or a third party. The acquisition of additional eligible assets will be discussed in more detail herein with reference to FIG. 3.

FIG. 2 is a block diagram depicting an alternative structure 200 of a financing program for managing REIT preferred securities, in accordance with an alternative embodiment of the present invention. As shown in FIG. 2, the bank 104 is created or exists as an entity, independent of and without the need for the BHC 102 of FIG. 1. The REIT sub 108 is created or exists as a direct subsidiary of bank 104 and does not include the capital corporation 106 as an intermediate subsidiary, as shown in FIG. 1. In most other respects, the structure 200 is structured and operates similar to the structure 100 of FIG. 1. The exemplary system 200 is illustrative and, in alternative embodiments of the invention, certain elements can be arranged differently, additional elements can be added, and/or certain elements can be omitted entirely without departing from the scope and spirit of the invention, such as, for example, certain exemplary embodiments may include the BHC 102 and other exemplary embodiments may include the capital corporation 106. In addition, it should be noted that what is shown as a single entity in FIGS. 1 and 2 could be multiple entities in actual practice, with each exchanging, for example, securities, assets, and cash between one another.

FIG. 3 is a flow chart depicting an exemplary method 300 for managing REIT securities issuance and administration using the structures set forth in FIGS. 1 and 2. The exemplary method 300 is illustrative and, in alternative embodiments of the invention, certain steps can be performed in a different order, in parallel with one another, or omitted entirely, and/or certain additional steps can be performed without departing from the scope and spirit of the invention.

Referring now to FIGS. 1, 2, and 3, the exemplary method 300 begins at the START step and proceeds to step 305, where the capital corporation 106 contributes a predetermined amount of eligible assets to the REIT sub 108. In certain alternative embodiments, another bank affiliate or subsidiary can contribute a predetermined amount of eligible assets to the REIT sub 108. In exchange for the eligible assets, the REIT sub 108 issues 100% of its common stock to the capital corporation 106. In one exemplary embodiment, the capital corporation 106 receives 100% of the common stock. In certain alternative embodiments, the REIT sub 108 issues a percentage of its common stock to the bank 104 or another bank affiliate or subsidiary. In yet another alternative embodiment, the common stock is held by multiple entities, such as the bank 104 and another bank affiliate or subsidiary, such that the multiple entities together hold 100% of the common stock. In this exemplary embodiment each holder of common stock is an affiliate, parent, or subsidiary of bank 104. The capital corporation 106, or another holder of the common stock, can sell, assign, or otherwise transfer the common stock to another entity, provided that the bank 104 or an affiliate, parent, or subsidiary maintains direct or indirect ownership of 100% of the common stock of the REIT sub 108. In one exemplary embodiment, the covenant to consent to consent dividends will accompany any sale, transfer, or assignment of the common stock of the REIT sub 108 and continue to apply to the REIT common stock. In one exemplary embodiment, the REIT sub 108 also issues up to 125 shares of Series B cumulative non-voting preferred stock. (not shown). In this exemplary embodiment, issuance of Series B stock enables the REIT sub 108 to satisfy the requirements under the federal tax code that in order for REIT sub 108 to maintain a status as a REIT, the beneficial ownership of the REIT sub 108 must be held by 100 or more persons. In one exemplary embodiment, “persons” can include all types of corporate entities.

In step 310, the capital corporation 106 covenants to consent to consent dividends under the common stock received from the REIT sub 108 in exchange for the eligible assets. In one exemplary embodiment, the covenant to consent to consent dividends is a part of the incorporation documents. Alternatively, in one exemplary embodiment, the covenant to consent to consent dividends may be a separate document attached to the incorporation documents, or a separate agreement entered into between the REIT sub 108 and the holders of the REIT common stock. In one exemplary embodiment, the covenant to consent to consent dividends provides that the holder of the common stock covenants to consent to the delivery of consent dividends for all dividend periods. A consent dividend is a hypothetical dividend distribution, in which the issuer, REIT sub 108, treats the consent dividend as a dividends-paid deduction and the holder, for example, capital corporation 106, treats the dividend as income for tax purposes; but, the holder never receives an actual cash or property distribution and the consent dividend amount is retained by the REIT sub 108. The effect is that the REIT sub 108 is deemed to have distributed a dividend, and the holder is deemed to have received a dividend for tax purposes. The covenant to consent to consent dividends ensures, at the initial conveyance of the common stock, that the holder, for example, capital corporation 106, will accept consent dividends at each dividend period. This, in turn, ensures that the REIT sub 108 is capable of distributing the regulatory percentage of its annual income, while maintaining capital adequacy. In one exemplary embodiment, the regulatory percentage of the annual income is determined by a regulatory agency, such as the IRS, and is equal to 90%. The regulatory percentage could be greater than or less than 90%, and such changes are within the scope of the invention, as the invention is suitable to any regulatory percentage.

In step 315, the REIT sub 108 issues REIT preferred securities to REIT preferred securities investors 110. In one exemplary embodiment, REIT preferred securities investors 110 include public and institutional investors. In one exemplary embodiment, REIT preferred securities are perpetual, non-cumulative, exchangeable series A preferred stock. In one exemplary embodiment, the REIT preferred securities cannot be called earlier than a first period of time after issuance, unless certain adverse tax, regulatory, or rating agency events occur. For example, in one exemplary embodiment, the REIT preferred securities are callable after a first period of time of five years from the date of issuance. In an alternative embodiment, the first period of time can be three years from the date of issuance. Further, if a dividend is deferred under the REIT preferred security in a particular dividend period, the dividend amount does not accumulate over future dividend periods. In addition, in certain exemplary embodiments, the REIT preferred securities do not provide for any coupon step-up. The conditions for exchange of the REIT preferred securities are discussed in detail below with reference to step 335 of FIG. 3. In certain alternative embodiments, the REIT preferred securities can include a coupon step-up; can be callable in greater than or fewer than five years, such as, for example, three years; and/or be cumulative.

In one exemplary embodiment, the REIT preferred securities entitle the REIT preferred securities investor 110 to one vote per share of REIT preferred securities on all matters submitted to a vote of the REIT preferred securities investors. In one exemplary embodiment, the voting rights for each share of REIT preferred securities is 1/10 of one vote. In addition, in certain exemplary embodiments, the REIT preferred securities investors 110 are prohibited from transferring shares or securities that would result in more than 50% in value of the outstanding shares of capital stock being owned by five or fewer individuals, or would cause its shares of capital stock to be beneficially owned by fewer than 100 persons.

In step 320, the REIT sub 108 uses proceeds from the sale of the REIT preferred securities to acquire additional eligible assets. In one exemplary embodiment, the assets are acquired from the capital corporation 106. In certain alternative embodiments, the REIT sub 108 can use proceeds from the sale of the REIT preferred securities to acquire additional eligible assets from the bank 104 and/or a bank 104 affiliate, parent or other third party. As discussed herein, eligible assets include, but are not limited to, agency mortgage-backed securities and non-agency mortgage-backed securities, including payments thereon. In addition, in certain exemplary embodiments, the REIT sub 108 uses the proceeds from both the sale of the REIT preferred securities and from the eligible assets for general corporate purposes and for paying the initial expenses of the REIT sub 108.

In step 325, the capital corporation 106 dividends proceeds received from the transfer of eligible assets to the REIT sub 108 to the bank 104. In an alternative embodiment, the capital corporation 106 dividends proceeds from the transfer of eligible assets to the REIT sub 108 to the BHC 102. In yet another alternative embodiment, the capital corporation 106 retains the proceeds. In step 330, the REIT sub 108 administers dividends to maintain its status as a REIT for United States federal income tax purposes. Step 330 is discussed in more detail below with reference to FIG. 4.

In step 335, an inquiry is conducted to determine whether an event relating to the capital adequacy of the bank 104 requiring exchange of REIT preferred securities for BHC preferred stock has occurred. In certain exemplary embodiments, events relating to the capital adequacy of the bank 104 requiring exchange of REIT preferred securities for BHC preferred stock include: the bank 104 becoming undercapitalized under guidelines set forth by the Office of the Comptroller of the Currency's (“OCC”) prompt corrective action regulations, the bank 104 being placed into conservatorship or receivership; or the OCC, in its sole discretion, directing such exchange in anticipation of bank 104 becoming undercapitalized in the near term or taking supervisory action that limits the payment of dividends, as applicable, by the bank 104, and in connection therewith directs an exchange. In alternative embodiments, other events related to capital adequacy can trigger a mandatory exchange of REIT preferred securities for BHC preferred stock. In one exemplary embodiment, the determination is made by the REIT sub board of the REIT sub 108.

If it is determined that an event has occurred requiring exchange of REIT preferred securities for BHC preferred stock, the “YES” branch is followed to step 340, where each REIT preferred security is exchanged for one share of BHC preferred stock. In one exemplary embodiment, BHC preferred stock has substantially equivalent terms as to dividends, redemption, liquidation preferences, and other subordination features, as the REIT preferred securities. The method proceeds from step 340 to step 345.

If, on the other hand, the REIT sub board determines that an event has not occurred requiring exchange of REIT preferred securities for BHC stock, the investors 110 holding REIT preferred stock retain the REIT preferred stock, and the “NO” branch is followed to step 345.

In step 345, an inquiry is conducted to determine whether the REIT preferred securities have matured or have been redeemed. For example, in one exemplary embodiment, the REIT preferred securities are callable after 5 years. As such, the REIT sub 108 can determine, after 5 years, whether to redeem the REIT preferred securities. If the REIT preferred securities have matured or have been redeemed, the “YES” branch is followed to the END step. If, however, the REIT preferred securities have not matured or been redeemed, the “NO” branch is followed to step 330, and proceeds as previously described herein.

FIG. 4 is a flow chart depicting an exemplary method 330 for administering dividends from the REIT sub 108 to maintain REIT status of the REIT sub 108. The exemplary method 330 is illustrative and, in alternative embodiments of the invention, certain steps can be performed in a different order, in parallel with one another, or omitted entirely, and/or certain additional steps can be performed without departing from the scope and spirit of the invention.

Referring now to FIGS. 1-4, the exemplary method 330 begins at step 405, where the REIT sub 108 accumulates income over a predetermined time period. In one exemplary embodiment, the predetermined time period is a financial quarter, however, other time periods, including annually, are within the scope of the present invention. The decision to declare dividends is at the sole discretion of the REIT sub board. The income accumulated comprises proceeds from the eligible assets, the sale of REIT preferred securities, and the sale of the common stock.

In step 410, an inquiry is conducted to determine whether to pay the full dividend to holders of the REIT preferred securities. In one exemplary embodiment, the determination is made by the REIT sub board and the holders of the REIT preferred securities are the investors 110. Electing not to pay the full dividend constitutes a deferral of dividend payments, in which the REIT sub 108 does not pay dividends in cash or property to the holders of the REIT preferred securities. In addition, if dividends are not paid to the holders of the REIT preferred securities, an actual dividend cannot be paid to holders of the common stock of the REIT sub 108. If the REIT sub board elects to pay the full dividend payments to the holders of the REIT preferred securities, the “YES” branch is followed to step 425, which is discussed in more detail below.

If the REIT sub board elects to defer, and not pay the full dividend to the holders of the REIT preferred securities, the “NO” branch is followed to step 415. In step 415, the REIT sub 108 is prohibited from paying dividends to holders of the REIT common stock holders, because the REIT preferred securities are ranked senior to the REIT common stock. As such, if the holders of the REIT preferred securities do not receive the full dividend, the common stock holders cannot receive a dividend.

In step 420, the BHC 102 and any of its subsidiaries are prohibited from paying dividends on its capital stock. The BHC 102 would have covenanted in favor of the holders of the REIT preferred securities that, if full dividends on the REIT preferred securities are not declared and paid for any dividend period, then BHC 102 and any of its subsidiaries, will not declare or pay dividends or other distributions with respect to any of its capital securities.

In step 425, an inquiry is conducted to determine whether the dividend amount paid to the holder of the REIT preferred securities, for example, the capital corporation 106, meets the predetermined regulatory percentage. If it is determined that the REIT sub 108 has paid at least the regulatory percentage of its annual income, the “YES” branch is followed to step 445, which is discussed in more detail herein below. Otherwise, the “NO” branch is followed to step 430.

In step 430, the REIT sub 108 declares a consent dividend to the REIT common stock holders. In exemplary embodiments, the common stock holder is the capital corporation 106. In an alternative embodiment, the common stock holder is the bank 104. In order to maintain REIT status, the REIT sub 108 must distribute, either by actual dividends or through consent dividends, at least a regulatory percentage of its annual income from REIT assets each year. In one exemplary embodiment, the regulatory percentage is equal to 90%; however, the regulatory percentage can be any amount between 0% and 100%. Thus, in step 430, the REIT sub board can declare a consent dividend in any amount necessary to reach the requirement of distributing 90% of its annual income.

A consent dividend is a hypothetical distribution, in which the issuer, for example, the REIT sub 108, treats the dividend as deductible interest expense, the common stock holder, for example, the capital corporation 106, treats the dividend as income for tax purposes, but, the holder never receives an actual cash or property distribution and the dividend amount is retained by the REIT sub 108. For U.S. federal income tax purposes, consent dividends are treated as distributions of income. As such, in step 435, the common stock holders pay taxes on the amount of the consent dividend. In step 440, the REIT sub 108 treats the consent dividend as a deductible income expense for accounting purposes.

In step 445, an inquiry is conducted to determine whether the current dividend period is a year end period. In one exemplary embodiment, a year-end period is the fourth financial quarter of a financial year. In alternative embodiments, a financial year can be any 365-day period as determined by the REIT sub board. If, in Step 445, the REIT sub board determines that the current dividend period is a year end period, the “YES” branch is followed to step 450, which is discussed in more detail herein below. Otherwise, the “NO” branch is followed to step 405, where the method proceeds as previously described herein.

In step 450, an inquiry is conducted to determine whether the REIT sub 108 has paid at least the regulatory percentage of its annual earnings. The earnings can be distributed through both cash dividends and consent dividends. If it is determined that the REIT sub 108 has paid at least the regulatory percentage of its annual income, the “YES” branch is followed to step 460, in which the REIT sub 108 maintains its status as a REIT. Otherwise, the “NO” branch is followed to step 455, in which the REIT sub 108 loses status as a REIT. Thus, the REIT sub 108 can maintain status as a REIT while retaining equity for rating agency and regulatory purposes by declaring consent dividends. The method then proceeds from step 455 or 460 to step 335 of FIG. 3.

In addition, in another exemplary embodiment, an investment bank or other entity advises or counsels a bank, bank holding company, other financial institution, or other entity to create, manage, execute, and/or issue the products, methods and structures set forth in FIGS. 1-8 related to REIT preferred securities in order to manage the advisees capital structure and, in some instances, issues consent dividends from the REIT or similarly structured entity so that the REIT maintains its REIT status. Further, as a part of this exemplary embodiment or in another exemplary embodiment, the investment bank or other entity markets the REIT preferred securities, securities having a beneficial interest in the REIT preferred securities and/or other securities for the bank, bank holding company or related entities thereto, other financial institution, or other entity to investors or other potential buyers of these securities. In addition, the investment bank or other entity can underwrite the REIT preferred securities, securities having a beneficial interest in the REIT preferred securities, and/or other securities or products set forth in FIGS. 1-8 for the bank, bank holding company or related entities thereto, other financial institutions or other entity. In these exemplary embodiments, the investment bank is capable of providing advice, management, marketing, and underwriting services to the financial institution to create a REIT or take and existing REIT and modify its earnings distributions as set forth in the exemplary embodiments of FIGS. 1-8 to provide a way for the REIT to retain dividend proceeds which are generally required to be paid to securities holders, while maintaining REIT status.

Although specific embodiments of the invention have been described above in detail, the description is merely for purposes of illustration. It should be appreciated, therefore, that many aspects of the invention were described above by way of example only and are not intended as required or essential elements of the invention unless explicitly stated otherwise. Various modifications of, and equivalent steps corresponding to, the disclosed aspects of the exemplary embodiments, in addition to those described above, can be made by a person having ordinary skill in the art without departing from the spirit and scope of the invention defined in the following claims, the scope of which is to be accorded the broadest interpretation so as to encompass such modifications and equivalent structures.

1. A method of managing a capital structure of a financial institution through management of earnings distributions from a real estate investment trust (“REIT”), comprising the steps of:
establishing the REIT as an affiliate of a first entity;
transferring at least one REIT asset from the first entity to the REIT;
issuing at least one REIT common stock security from the REIT to the first entity in exchange for the REIT assets, wherein the first entity covenants to consent to a consent dividend;
issuing a plurality of REIT preferred securities from the REIT to a plurality of investors; and
declaring at least one consent dividend, wherein a total amount of dividends paid comprises a regulatory predetermined percentage of the income for the REIT.

2. (canceled)

3. (canceled)

4. The method of claim 1, further comprising the steps of:
receiving cash proceeds from the investors in exchange for the REIT preferred securities;
exchanging the cash proceeds for additional REIT assets, wherein the additional REIT assets are held by the REIT.

5. The method of claim 4, wherein the exchange is with the first entity, wherein the first entity receives the cash proceeds and wherein the first entity is a subsidiary of a bank.

6. (canceled)

7. (canceled)

8. The method of claim 7, further comprising the step of entering into a covenant to consent to the consent dividend with each entity holding the REIT common stock securities.

9. The method of claim 1, wherein the total amount of dividends paid comprises
the at least one consent dividend payment, a cash dividend payment to the plurality of investors, and a cash dividend payment to the first entity.

10. The method of claim 1, further comprising the steps of:
deferring at least a portion of a cash dividend payment to the plurality of investors;
deferring at least a portion of another cash dividend payment to the first entity;
declaring a consent dividend payment to the first entity comprising a difference in the regulatory predetermined percentage of the income for the REIT and the sum of a total amount of dividends paid to investors and the total amount of cash dividends paid to the first entity;
paying an income tax on the consent dividend payment at the first entity; and
retaining proceeds of the consent dividend in the REIT.

11. (canceled)

12. The method of claim 1, wherein the regulatory predetermined percentage of the income of the REIT is ninety percent.

13. The method of claim 1 further comprising the steps of:
receiving the consent dividend payment at the first entity comprising at least the regulatory predetermined percentage of income for the REIT;
paying an income tax on an amount of the consent dividend payment at the first entity; and
retaining proceeds in the amount of the consent dividend payment in the REIT.

14. The method of claim 1, further comprising the steps of:
providing a bank holding company, wherein the first entity is a subsidiary of the bank holding company;
deferring a cash dividend payment to the investors; and
preventing the bank holding company, any affiliate of the bank holding company, and any subsidiary of the bank holding company from paying another cash dividend on a capital stock.

15. The method of claim 1, further comprising the steps of:
providing a bank holding company, wherein the first entity is a subsidiary of the bank holding company;
issuing a plurality of bank holding company preferred securities from the bank holding company to the investors after an event relating to a capital adequacy of the first entity requiring exchange; and
transferring the REIT preferred securities from the investors to the bank holding company in exchange for the bank holding company preferred securities.

16-19. (canceled)

20. A method of managing a capital structure of a financial institution through management of earnings distributions from a real estate investment trust (“REIT”), comprising the steps of:
establishing the REIT as an affiliate of a capital corporation, wherein the capital corporation is a subsidiary of a bank;
transferring a plurality of REIT assets from the capital corporation to the REIT;
issuing a plurality of REIT common stock securities from the REIT to the capital corporation in exchange for the REIT assets, wherein the capital corporation covenants to consent to a consent dividend for the REIT common stock securities;
issuing a plurality of REIT preferred securities from the REIT to a plurality of investors;
declaring at least one consent dividend payment to the capital corporation, wherein a total amount of dividends comprises at least a regulatory predetermined percentage of the income for the REIT;
receiving the consent dividend payment at the capital corporation;
paying an income tax on an amount of the consent dividend payment at the capital corporation; and
retaining proceeds in the amount of the consent dividend payment in the REIT.

21. (canceled)

22. The method of claim 20, further comprising the steps of:
receiving cash proceeds from the investors in exchange for the REIT preferred securities;
transferring the cash proceeds to the capital corporation;
transferring additional REIT assets from the capital corporation to REIT; and
transferring the cash proceeds from the capital corporation to the bank.

23. The method of claim 20, wherein all of the REIT common stock securities are held by at least one affiliate of the bank.

24-26. (canceled)

27. The method of claim 20, further comprising the steps of:
providing a bank holding company, wherein the bank is a subsidiary of the bank holding company;
deferring the cash dividend payment to the investors; and
preventing the bank holding company, any affiliate of the bank holding company, and any subsidiary of the bank holding company from paying another cash dividend on a capital stock.

28. The method of claim 20, further comprising the steps of:
providing a bank holding company, wherein the bank is a subsidiary of the bank holding company;
issuing a plurality of bank holding company preferred securities from the bank holding company to the investors after an event relating to a capital adequacy of the bank requiring exchange; and
transferring the REIT preferred securities from the investors to the bank holding company in exchange for the bank holding company preferred securities.

29-33. (canceled)

34. A method of managing a capital structure of a financial institution through management of earnings distributions from a real estate investment trust (“REIT”), comprising the steps of:
receiving at least one REIT asset into the REIT;
issuing at least one REIT common stock security from the REIT,
entering into an agreement involving the REIT comprising a covenant to consent to a consent dividend;
issuing a plurality of REIT preferred securities from the REIT; and
declaring at least one consent dividend, wherein a the amount of the consent dividend comprises a regulatory predetermined percentage of the income for the REIT.

35. The method of claim 34, wherein the REIT common stock security comprises the covenant to consent to the consent dividend.

36. (canceled)

37. The method of claim 34, further comprising the step of retaining the amount of the consent dividend at the REIT as proceeds.

38. The method of claim 34, further comprising the step of exchanging the REIT preferred securities for at least one other preferred security.

39. The method of claim 38, wherein the other preferred security comprises bank holding company preferred securities.

40-49. (canceled)
